(19) United States
(12) Patent Application Publication
(10) Pub. No.: US 2002/0131267 A1
(43) Pub. Date: Sep. 19, 2002

(54) ILLUMINATION BY HAND-OPERATED POWER TOOLS

(76) Inventor: ANTHONY ALFRED VAN OSENBRUGGEN, AUCKLAND (NZ)

Correspondence Address: YOUNG & THOMPSON, 745 SOUTH 23RD STREET 2ND FLOOR, ARLINGTON, VA, 22202

(21) Appl. No.: 09/508,190

(22) PCT Filed: Jul. 8, 1998
(86) PCT No.: PCT/NZ98/00096

(30) Foreign Application Priority Data
Jul. 10, 1997 (NZ) 328305
Sep. 30, 1997 (NZ) 328880

(51) Int. Cl. F21V 33/00

(52) U.S. Cl. 362/109; 362/119

(57) ABSTRACT

An illuminator adapted for use on a hand-operated tool such as a power tool (1000) comprises a low-profile, flexible, adherent laminated housing (900), including one or more lamps (906, 907) capable of illuminating a work surface beneath the power tool. This permits a user to work with the tool in conditions of poor visibility. The housing includes connectors. A battery pack (1002) may be attached to a surface of the tool or concealed within an attachable or accessory handle (1002A). Versions including lamp control are also described.

### TECHNICAL FIELD OF THE INVENTION

This invention relates to means for achieving portable work-surface lighting for use with, and more particularly upon tools including power tools such as electric drills; cordless electric drills, drivers, electric angle grinders, portable circular saws, drop saws, and the like.

### BACKGROUND

Workers are often called on to use power tools in poorly lit places, and there is therefore a need to provide extra lighting in some way. Sometimes it is not feasible to provide general illumination in the workspace and therefore illumination, built into the tool, and focused onto the workplace itself is an alternative.

Known prior art includes:

Screwdrivers having batteries in the handle and a bulb, behind a clear plastic blade holder, shining light at about the end of the blade.

Solder guns with a prefocused bulb aimed at about the position of the wire hairpin.

A flexible light band, carrying an array of light-emitting diodes or LEDs for use around the chuck of a tool, as described in U.S. Pat. No. 5,473,519 to McCallops et al. This invention is intended, as set out in claim 1, to indicate tool function to an operator. This explains why the lamps are directed tangentially rather than at a work surface.

A power tool such as a rechargeable screwdriver, having illumination built into an existing battery pack attached at the end of the trigger grip, as described in U.S. Pat. No. 5,169,225 to Palm.

Some tools also include a light beam to indicate the direction of cut, such as the laser diode mounted on a hand-held circular saw guard as described in U.S. Pat. No. 5,461,790 to Olstowski.

Nevertheless there is no known illuminator that is adapted for use with the perforated abrasive disks on an angle grinder, as described in PCT/NZ96/00035 to van Osenbruggen and considerations of this problem have led to a more general solution to the illumination of a wide variety of tools including, but not limited to power tools.

### OBJECT

It is an object of this invention to provide an illumination device compatible with a variety of power tools or one that can provide the public with a useful choice.

### STATEMENT OF INVENTION

In a first broad aspect the invention provides illumination means for providing portable, locally applied illumination upon an item such as a hand-held tool, wherein visible light-emitting means is provided from within a housing having a low profile; the housing providing for coupling of the visible light-emitting means to a source of energy and being capable of being attached by an attachment means compatible with a variety of existing items, so that, when in place and when in use, an effective amount of light may be cast onto a work surface.

In a related aspect the attachment means comprises a layer of an adhesive material capable of holding the attachment means onto the item, and the housing for the illumination means is flexible.

In another related aspect the light-emitting means comprises at least one filament lamp, connected to a flexible electrical conducting means; the electrical conducting means being connected to one or more sources of electric power, the at least one lamp being housed upon or within a resilient non-conducting material, so that the illumination means is capable, on installation, of conforming to a variety of shaped surfaces.

In a further related aspect the at least one filament lamp is provided with heat dissipation means comprising at least one heat conducting means laid out upon or within the housing, so that in use the heat produced by the at least one lamp is distributed about the housing.

In a yet further related aspect the heat dissipation means also serves as the flexible electrical conducting means and is comprised of a metal foil.

In a second broad aspect the illumination means is provided within a compatible, functional accessory for the power tool, so that when in place, the accessory containing the illumination means is capable of directing an effective amount of light onto the work surface as well as being capable of carrying out its usual function.

In a related aspect the accessory comprises an additional handle suitable for attachment to the hand-held tool.

In a further related aspect the illumination means within the accessory is powered from a battery pack adapted to function with the accessory.

In a yet further related aspect the tool is an electrically powered tool and the illumination means draws its power from the power provided to the power tool.

In a still further related aspect the visible light is generated external to the illumination means and is carried by means of one or more light conducting pathways into the illumination means from where an effective amount of light may be cast onto a work surface.

In an even further related aspect the illumination means is capable of producing a flashing light wherein each flash is timed so as to be substantially in phase with the presence, adjacent to the illumination means, of a perforation in the abrasive disk attached to the spindle of the angle grinder, so that the light is emitted only through the perforation.

In another related aspect the illumination means is capable of emitting light as a series of short pulses so that the operator is provided with a view of the workplace but battery life is conserved. A flexible housing may be used with a type of illuminator wherein the light-emitting means comprises one or more solid-state lamps and control means, to limit current or the proportion of time that the lamps are lit.

In a third broad aspect the invention provides illumination means for illuminating the area surrounding a power tool wherein the illumination means is capable of being fitted onto an existing power tool by replacement of an original handle with a modified handle containing or comprising the illumination means, the illuminator being capable of emitting light onto one or more zones within the working area of the tool.

Preferably one zone comprises a broad area within which the tool is to be used.

Preferably a different zone comprises a line, delineating a cutting line along which the tool is to be used.

Preferably the source of light is contained within the modified handle.

Alternatively the source of light may be remote; connected to the modified handle by means of one or more wires.

Alternatively the source of light may be within the modified handle and the light is conducted to an emission site by means of one or more fibre-optic cables (or the like).

Preferably the illuminator is powered from a battery pack contained within the attachable handle; the batteries being replaceable from time to time.

Optionally, if the handle is fitted to a mains-powered tool, the battery or batteries may be recharged automatically.

Optionally the illuminator is powered from the power supply to the tool, using connectors positioned so as to make contact when the handle is in place.

Preferably the illuminator emits light from one or more halogen bulbs.

Optionally the illuminator emits light from one or more xenon flash or xenon arc bulbs.

Optionally the illuminator emits light from one or more solid-state lamps.

Optionally the illuminator is capable of being powered by inductive power transfer.

Optionally the inductive power transfer employs a pickup coil placed so as go be able to collect a changing magnetic flux developed by a magnet or magnets rotating on the shaft of the power tool.

In a second broad aspect the invention provides an illuminator for an angle grinder that can be mounted at the end of the tool nearer the spindle, the illuminator being capable of emitting light onto one or more zones within the working area of the tool.

Optionally the illuminator is capable of producing a flashing light wherein each flash is timed so as to be synchronous with the presence of a perforation in the abrasive disk attached to the spindle of the angle grinder.

In a third broad aspect the invention provides an illuminator for a hand-held power tool such as an electric drill, that can be mounted near the cutting end of the tool, the illuminator being capable of emitting light onto one or more zones within the working area of the tool.

Preferably the illuminator is powered from a battery pack contained within an attachable handle.

Preferably the handle conforms to a standard pattern for power tools, at least in relation to means for affixing the handle to the tool.

Optionally the illuminator is powered from the power supply to the power tool.

Optionally the illumination means is in the form of an external collar or grip, capable of being attached around an existing handle.

Preferably such an external collar is capable of drawing power from the power supply to the power tool.

In a fourth broad aspect the invention provides an illuminator for an angle grinder that can be mounted at the end of the tool nearer the spindle, the illuminator being capable of emitting light onto one or more zones within the working area of the tool.

Preferably the illuminator is powered from a battery pack contained within an attachable handle

Optionally the illuminator is powered from the power supply to the angle grinder or other power tool.

Optionally the illuminator can flash in short pulses, so that the operator acquires an view of the workplace but there is a useful proportion of rest time so that battery life can be conserved. An example of this might be ON for 0.75 sec, off for 0.75 sec, so achieving double the battery life. Additionally, flashing may make a guiding line more visible.

In a fifth broad aspect the invention provides an illuminator optimised for use with a hand-held circular saw or the like, wherein the illuminator is built into a replaceable handle capable of creating a broad beam of light and also of creating a narrow beam, for directing a cut.

Alternatively the illuminator is built into a handle comprising part of the casing of the saw capable of creating a broad beam of light and also of creating a narrow beam, for directing a cut.

Preferably the narrow beam is generated from a solid-state laser diode or the like.

### DESCRIPTION OF FIGURES

The preferred embodiments to be described and illustrated in this specification are provided purely by way of example and are in no way intended to be limiting as to the spirit or the scope of the invention.

### DRAWINGS

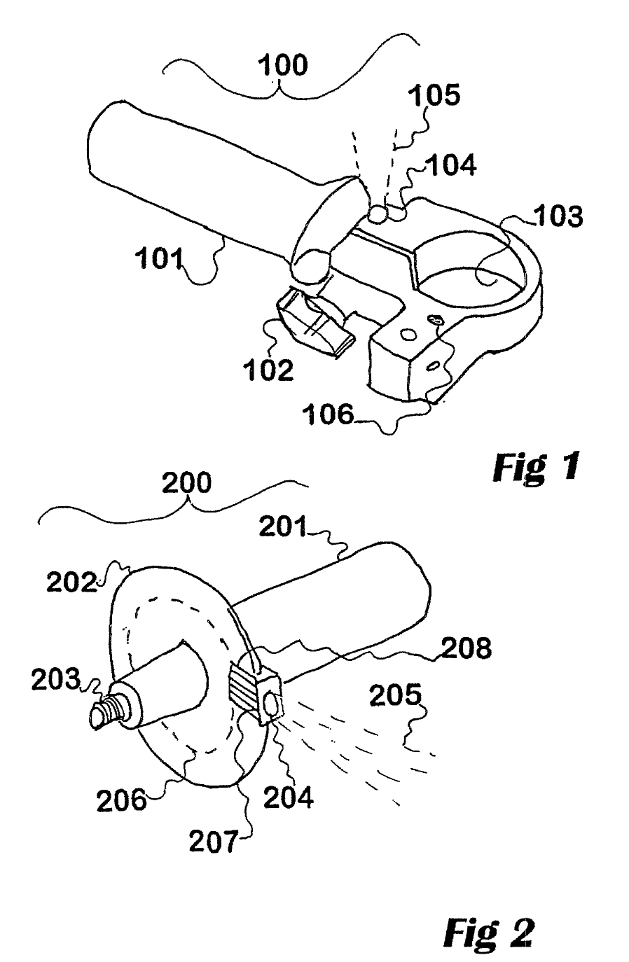

FIG. 1: shows a handle and illuminator suitable for use with a power tool, wherein the standard means of attachment is around a collar of prescribed diameter.

FIG. 2: shows a handle and illuminator suitable for use with a power tool, wherein the standard means of attachment is by means of a screw thread received into a threaded aperture in one side of the tool.

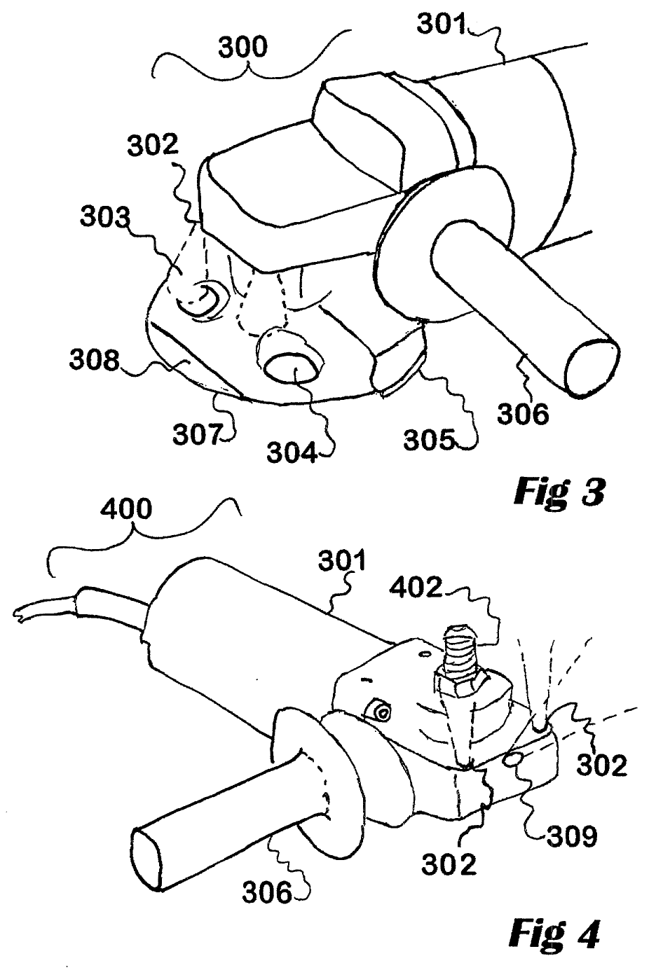

FIG. 3: shows an angle grinder with handle and an illuminator assembly suitable for use on the front of an angle grinder.

FIG. 4: shows an angle grinder with built in illuminators from below.

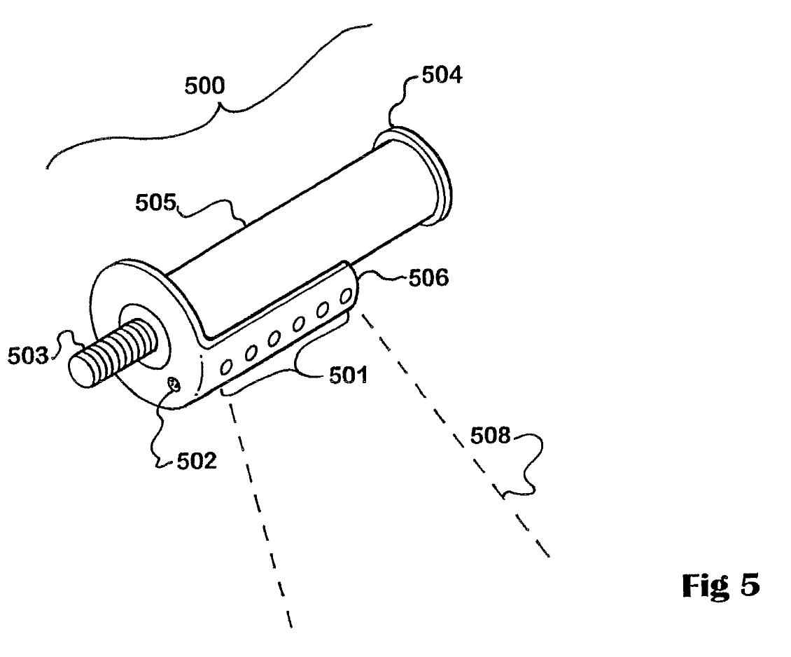

FIG. 5: shows a handle having two kinds of illuminator suitable for use in both lighting the working area and for delineating the cutting line, such as for a hand-held circular saw.

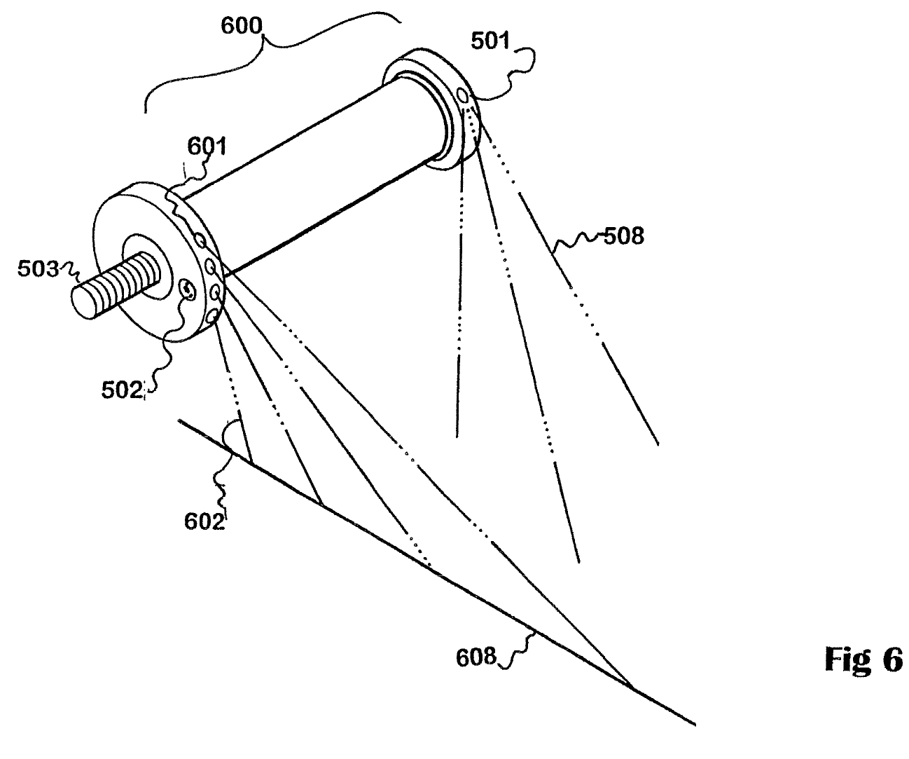

FIG. 6: shows another handle having two kinds of illuminator suitable for use in both lighting the working area and for delineating the cutting line, such as for a hand-held circular saw.

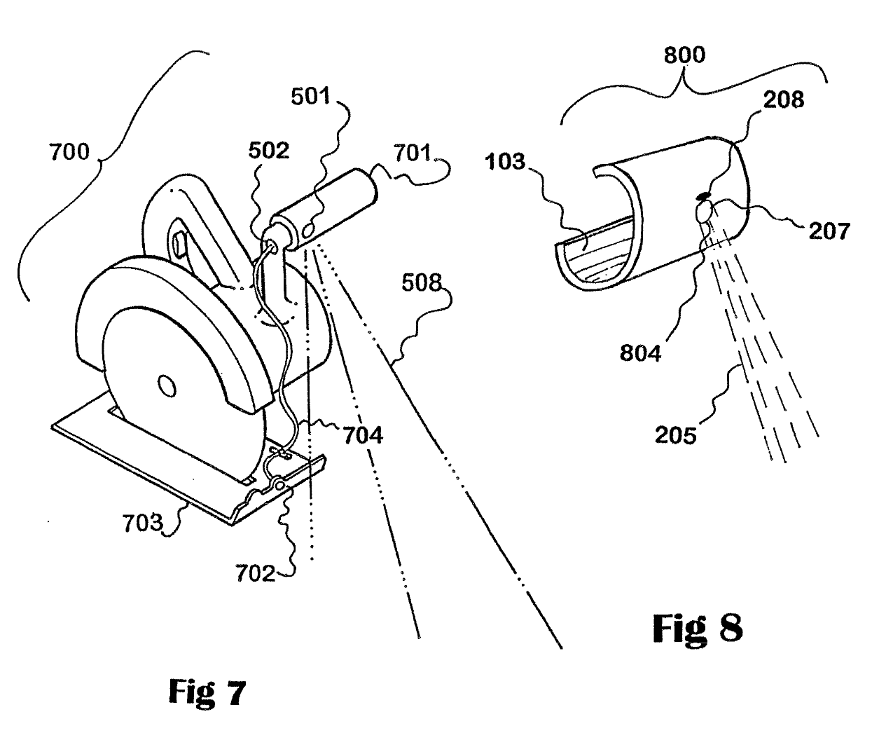

FIG. 7: shows a hand-held circular saw having a handle as above, including illumination means suitable for use in lighting the working area and for delineating the cutting line.

FIG. 8: shows an illuminator mounted on a sleeve that can be clipped over or otherwise affixed to the handle or the body of a tool.

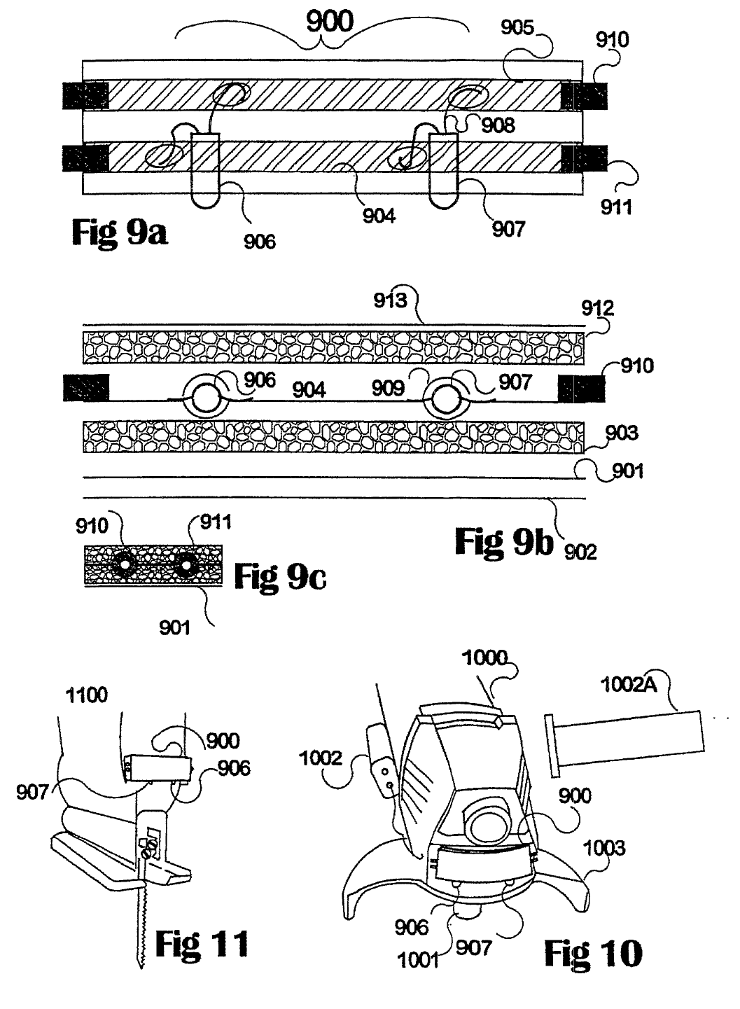

FIG. 9: shows an illuminator of the “low-profile, stick-on” type.

FIG. 10: shows this type of illuminator attached to an angle grinder.

FIG. 11: shows this type of illuminator attached to a jigsaw.

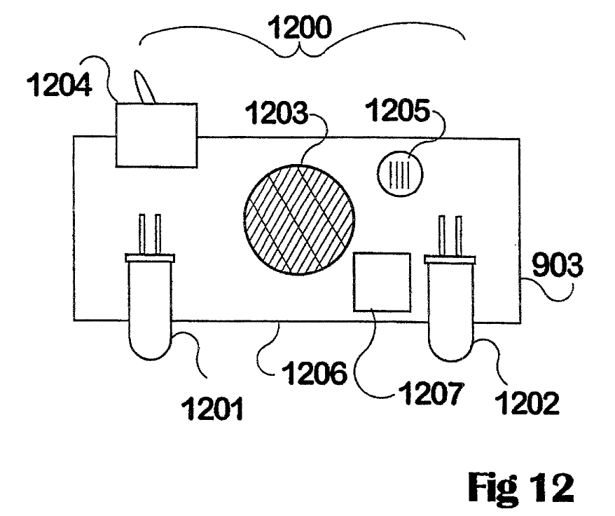

FIG. 12: shows an illuminator of the “low-profile, stick-on” type employing solid-state lamps and integrated-circuit control.

### PREFERRED EMBODIMENT

The reader should bear in mind that the preferred embodiments to be described herein are provided by way of illustrative example only, and must not be taken to be limiting as to the spirit or scope of the invention.

Some types of the invention involve the use of replacement parts for standard parts (e.g. Makita part # 27503-9; side handle or Makita part # 152487-3; side handle for angle grinder) of commonly available power tools, wherein the replacement parts may also serve as battery packs as well as serving as handles. Other embodiments of the invention diverge from that common origin. (Makita; Japan)

### EXAMPLE 1

As seen in FIGS. 1 and 2, an illuminator for a power tool can be constructed to match existing standards for handle attachment. Commonly an electric drill or the like is provided with means for attachment of a handle near the chuck. This helps the operator to hold the tool steady, even if torque results as reaction from the action of the bit against work material. Normally such handles are provided with the ability to be mounted on one side or the other, in case the operator is left-handed or right-handed.

In FIG. 1, 100 shows a handle modified to be used with a power tool having a collar of certain diameter, which in use is fitted inside the aperture 103 and a clamping screw is tightened with the knob 102 so that the handle is held tight. The actual handle 101 is in this invention made hollow and serves as a battery holder, with a suitable number of (preferably) rechargeable batteries inside. These are connected usually at least with a switch to one or more lamps.

Current-limiting means may be preferred. In fact we have allowed for active control by means of a light-dependent resistor 106. This, with suitable control circuitry, may allow the lamp to be energised only in dark environments or, by responding to the lamp's effect, flash on and off and so increase the battery life. Lamp 104 is directed generally towards the work surface. A beam of light 105 may be directed by laterally moving the lamp, moving a reflector, by moving a lens from side to side, or by adjusting the focus.

Preferably the handle 101 is replaceable so that a fresh set of batteries can be connected without losing time.

One useful option is to provide some electric contacts on the handle, that connect with similar contacts on a mating surface (103) and collar of the tool, that may be used to power the illuminator (104) and/or to recharge batteries housed in the handle, or to supply power to the motor of cordless tools or to supplement the main battery pack of cordless tools. Thus the handle is not totally dependent on batteries that are recharged elsewhere and inserted into the handle.

In FIG. 2, the handle 200 is of a type adapted for screwing by means of the thread 203 into a threaded aperture. Handles of this design usually include a broad collar 202, to help keep the operator's hand from slipping too close to cutting edges. In this version we have again stored batteries in the handle 201, the lamp 204 directs a beam of light 205 towards a desired direction, and in order to compensate for the possibility that when the invention is tightly screwed into the power tool the lamp is not directed properly, the outer part of the collar can be a sort of slip ring (206) so that the actual lamp 204 can be at any part of the periphery of the collar 202. The lamp holder 207 may also be mounted on a hinge 208 so that independent adjustment of the lamp is possible.

### EXAMPLE 2

This example is an illuminator (see FIG. 3) for an angle grinder 301 that can be mounted at the end of the tool (300) nearer the spindle, or built into the tool, the illuminator being capable of emitting light from lamps 302 along paths 303 that are aimed at or through apertures 304 and 308, and thereby form a “transparent” area 307 that is provided for within certain types of abrasive disk and within certain types of backing plate so that the user can see the area of the work surface that is either about to be abraded, or that is being abraded. These types of disk are the subject of earlier patent applications by the inventor and his assignees. In particular they offer the advantages of (1) visibility of the work area and (2) provide for cooling and dust removal. In FIG. 3, 305 is a guard that protects the operator from some danger. FIG. 4 shows the same device 400 from below; including an illuminator, with the abrasive disk, backing plate, and guard removed. The spindle 402 is visible, and so are the positions of a pair of lamps 302; and a forward-placed lamp 309. (This lamp may optionally be even more powerful than the downward-facing lamps. It may be particularly useful for showing the operator where surface irregularities are to be found on a work surface.)

Generally an abrasive disk modified in this way has the apertures spinning along reasonably predictable paths or zones within the working area of the tool, so that the location and direction of the beam or beams of light can be pre-determined. One or more halogen or xenon bulbs are a preferred source of light. Alternatively, one or more solid-state lamps may be used, such as high-efficiency red or yellow light-emitting diodes, or a solid-state visible laser device.

Optionally the illuminator is capable of producing a flashing light wherein each flash is timed so as to be synchronous with the presence of a perforation in the abrasive disk attached to the spindle of the angle grinder. This function may be provided by an electronic module such as an integrated circuit. It may generate a higher internal voltage than the typically 3 V for the lamps so that a solid-state switch such as a power MOSFET can be driven. Further flash patterns could be programmed in if the tool is left a lone for a long period; perhaps lost in the dark. (This type of feature can also be included in the handles of FIGS. 1 and 2). Solid-state lamps, and also xenon strobe lamps, can be driven with a series of pulses and these could be timed so that each pulse of light occurs as the aperture 304 and 308 passes beneath a lamp. Thus the operator's view seems to be a continuous (non-flickering, at working speeds) view of the work surface without obstruction by the solid parts of the abrasive disk and backing plate. Alternatively the lamp may be run continuously and the backing plate may be blackened to achieve much the same effect.

This concealed illuminator (FIG. 4) or an illuminator fixed into place essentially as shown in FIG. 3 (401) can be powered from a battery pack contained within an attachable handle 306, or by contacts located between mating surfaces (103, 208, 209) and the body of the tool, by means of a cable carrying power between the tool and the lamp, or may be powered from the power supply to the tool.

For strobing flashing lamps, the illuminator is capable of being either powered from a pickup coil acting as a generator in combination with a magnet or magnets rotating on the shaft of the angle grinder, or powered in some other manner and strobe pulses are obtained from magnetic or optical detectors of rotational position.

### EXAMPLE 3

FIG. 5 shows a handle 500 capable of being used as an accessory or replacement for a hand-held circular saw, including provisions for two kinds of illuminator; here a bank 501 of light-emitting diodes (or the like) is provided for a wide beam 508, for general illumination and also an outlet 502 for an intense beam of light 509 such as from a solid-state laser diode. That outlet 502 may either emit the light generated by a laser diode concealed within the handle and conducted through a fibre optic cable 507, or the outlet may instead be an electrical outlet to a remote diode assembly, which generally needs at least three; preferably four wires for the lamp supply current and also a feedback photodiode signal used to regulate the current through the laser diode. The handle 500 would generally be a self-contained unit, of dimensions similar to those of the plain handle supplied with the circular saw, and in one preferred form at least would include one or more batteries inside the handle. 504 is a removable lid for changing the batteries. 503 is a standard stud for threading the handle onto the body of the saw unit. Note that in case the stud, when tightened up, does not result in the handle pointing in the correct rotational orientation, we provide for a screw within the body of the saw to be tightened so as to lock the stud so that it can be secured in a desired orientation. Our LED array 501 is a diagrammatic indication of a broad-beam lamp. It has been placed within a shield normally concealing the operator's hand. High-intensity LEDs available at the present time would project from the handle, but in a few years time we expect that they can be provided in a flush mounting package and preferably one that can employ a rear backing plate 506 of metal to help dissipate heat generated within the lamps. Preferably the handle includes means to cause the high-intensity beam to flicker on and off, so that its position is more obvious. Causing the (usually) red line delineating the cutting line to flash periodically (such as at about 0.5 sec on, 0.5 sec off) should enhance its visibility. FIG. 6 shows an alternative design of handle, in which there is a series of light-emitting units 601 that are arranged so that they illuminate a line, and a broader illumination beam 508 is provided from a separate light-emitting area 501. Again, the stud 503 can be locked into place, using for example an Allen screw.

If the laser diode is placed within the handle, the connector 502 couples light along a fibre-optic cable to an emitting point physically placed at about the position of the guide on the shoe of the circular saw. This type of emitting point would then comprise a polished end of the optical fibre and a focusing lens, preferably providing a little astigmatism in order to elongate the beam in the vertical axis, as described elsewhere. If on the other hand the laser diode itself is placed at the emitting point, the connector 502 connects to a copper multi-wire cable running to the emitting point. This emitting point would then comprise the laser diode itself and a focusing lens, preferably providing a little astigmatism as described elsewhere.

The handle can cast a broad beam of light towards the area of the working surface that is about to be cut. Our preferred light source—based on present-day components—is a red laser diode, because it is insensitive to vibration, because the source is battery-compatible, because the red beam is bright and well-defined and because the beam can be very narrow especially in the axis that we will use as the horizontal axis (assuming a horizontal work surface). Some beam spreading in the vertical axis converts the light from a pencil beam into a widened beam, aimed forwards and slightly downwards, and so makes a line upon a flat work surface.

In a third version, (but one that is similar in principle to that of FIG. 6) one or more high-brightness light-emitting diodes are used as the light source instead of the laser diode. A special-purpose light-emitting unit designed for this purpose may contain a number of individual LED crystals mounted in a line across the base of the lamp unit and a lens is capable of forming an image of the crystals on the work surface. This lens may be tilted so that both near and far images are point-like. This lens may be formed into the plastic capsule of the LED. The user may then see a dotted line rather than a continuous line, but that should not detract from the invention. It may be possible to energise the chips in a sequence so that the operator sees a travelling “worm” of light along the path 608 to be cut. Filament lamps may be used instead of semiconductor-based lamps but are relatively sensitive to vibration.

FIG. 7 illustrates a hand-held circular saw bearing a handle 701 provided at the time of manufacture (whether made by the manufacturer or brought in as an OEM package) and bearing illumination means 501 (broadbeam) and 502 for line illumination connected by cable (fibre optic-for a concealed, built-in laser diode, or electrical, for a “local” laser diode to 704 and 702—the emitting site—down on the shoe 703.

FIG. 8: shows an illuminator mounted on a sleeve that can be clipped over or otherwise affixed to the handle or the body of a tool. This device could use pea bulbs (filament lamps), or solid-state lamps. A connector to a power source is not shown.

### EXAMPLE 4

A further means for tool illumination has been developed for use upon any kind of tool. It is a low-profile “stick-on” illuminator. FIG. 9 shows an illuminator according to this example, and FIGS. 10 and 11 show this type attached to a jigsaw and to an angle grinder. In FIG. 9, the interior of the illuminator is shown in surface view in FIG. 9a, a longitudinal section “exploded view” is shown in FIG. 9b, and one end is shown in FIG. 9c. The illuminator is made from a series of strips laminated together to form a flexible “illuminator strip” of indeterminate length. Here, we show two light bulbs but any number from 1 to 10 bulbs seems practicable for the immediate application of tool illumination. Note that it appears sensible to make this type of illuminator as a continuous strip of great length, to be cut up into short pieces and provided with connectors according to immediate needs.

FIG. 9b shows, at the innermost or “against-tool” surface, a layer of double-sided sticky tape 901 having (before application) the usual protective surface layer 902 which may be peeled away. Next is a layer of neoprene rubber foam or the like 903, which is about 3-4 mm thick in the prototype. This layer may have depressions cut or burnt into it (not shown) to accommodate the light bulbs. The next region holds the electrical apparatus. A pair of copper foil strips (904, 905), typically 0.1 to 0.3 mm thick and about 6 to 8 mm wide run along the length of the illuminator, side by side but with an adequate separation for the avoidance of contact. These strips are easily deformed at selected positions in order to accept the preferred small krypton-filled lamps (906, 907) e.g “White Star” of the type used in “Arlec” or Maglite” torches. These lamps have operating requirements of typically 3 V at 150 mA, or 1.5 V at 100 mA and have flying leads. One flying lead (e.g. 908) is soldered to each of the copper foil strips.

Preferably, extra copper foil 909 is also soldered (on one side at least) over the upper side of the lamp, so that heat (up to 0.5 W from each lamp) emitted in most directions or carried along the flying leads is conducted along the foil and dissipated over the entire illuminator rather than being concentrated at the position of the lamp, on the foam. A similar cover could be provided by folding the foil. A pair of contacts (910, 911) is provided at each end of a given foam strip, for convenience. A second layer of foam (912) is glued over the copper foil strips and onto the first layer of foam, and optionally an adhesive and surface-protecting layer (913) may be glued over the top.

We prefer to duplicate the connectors at both ends so that either left-handed or right-handed operators can set up their tool as required with the electrical lead out of the way.

A power supply for the illuminator may comprise a battery holder 1002, preferably with an on-off switch and optionally an indicator such as a flashing LED, which can be attached by double-sided tape at some other convenient position over the tool. An accessory handle may contain a battery for supplying the illuminator or even to supplement the power to the tool itself, in the case of cordless power tools. We find slide switches are suitable. Alternatively, ambient light sensing means and control means (as is known in the art) may automatically determine whether or not the lamps are energised. Wires taken over the surface of the tool (optionally glued down) may carry the current. Alternatively power can be taken from an attachable handle, optionally fitted with a convenient type of contact means at the screw end connecting to a washer bearing ring-commutator type contacts and connected to wires may be used. This type of washer may be constructed using printed-circuit board material. Alternatively the tool itself, if it is a type of electric power tool, may supply power to the lamps, possibly with a few turns of wire wound within an inductor assembly. Here, a constant-current output would be desirable so that variations in tool demand do not result in variations in lamp supply.

FIG. 10 shows an angle grinder 1000 having an illuminator of the type described above (900) attached at its fronts with two lamps 906 and 907 aimed downwards at the working area about the arbor 1001. (The guard 1003 is shown; no cutting or sanding disk is shown here). An area of about 80×50 mm is adequately illuminated. A battery holder 1002 may be attached at a convenient place on the body of the tool. Alternatively a handle, 1002A may supply power.

FIG. 11 shows a jig saw 1100 having an illuminator 900 attached at the very front of the housing, where the lights (e.g. 906) are suitably positioned for illuminating the general area of the work surface about to be machined.

This illuminator construction has a number of advantages; it can be used with any type of power tool, it is effective in terms of the usefulness of the light delivered, even through a spinning angle grinder blade, it is cheap to make, it is deformable and can be bent to conform to the shape of an object to be illuminated—not only power tools but also hand tools such as screwdrivers and spanners, and even other objects such as helmets, gloves, or the like. For a bicycle helmet, warning lights may be red at the rear. While the wire from the battery holder to the lamp is somewhat inconvenient, a number of possible solutions can be included in future tools, such as internal wiring, or external grooves into which wiring can be pressed and held in place.

The bulb life in practice is of the order of the rated 100 hours; factors enhancing bulb life, despite the intense vibration occasionally experienced include cushioning by the foam surround and the adequate heat sinking. (In fact an angle grinder itself may not last more than 300-500 hours of actual use). Consequently we do not consider it useful to provide for replacement of bulbs, although clearly the provision of bulb sockets is not a radical change. The foam material tends to give on impact. The entire construction does not protrude and become an obstruction, or catch items. The pattern of the light is “widely scattered” because these bulbs do not include internal focusing. However, if bulbs were made with a glass thickening in the end, acting as a lens, there may be an advantage, depending on lens power, the specific application, and geometry.

If light-emitting diode technology (or other solid-state lamp technology) improves in terms of visible light output, such lamps may become acceptable replacements for the presently preferred krypton-filled tungsten filament lamps.

Hence FIG. 12 shows such an arrangement; again on a flexible substrate 903 as per the previous description, with (preferably) two high-brightness light-emitting diodes 1201 and 1202 directed substantially along the plane of the substrate, so that they will be directed downwards from a mounted illuminator. (For simplicity we have not shown details such as of interconnections; however interconnections can easily be deduced by those skilled in the art). Preferred diodes (currently available types) are amber, 3 to 5 candela output. The example also includes a battery 1203 of the “button” type, an light-dependent resistor 1205, an integrated circuit 1207, and a switch. Minimally, the circuit would provide a switch, current-limiting means, and the diodes. The current limiting means may be the integrated circuit 1207. Optionally the circuit can switch itself on, on detecting vibration or tilting, or if the optional light-dependent resistor detects darkness. Optionally, the integrated circuit can provide a series of flashes; such as 0.2 seconds ON, 0.5 seconds OFF, or some such sequence, so that the operator sees the work but battery life is conserved. In that case the integrated circuit may be of the LM555 family type. In its completed form, the components visible in FIG. 12 will be covered with a resilient layer as indicated generally in FIG. 9.

### ADVANTAGES

1. The invention can be used with a wide variety of existing power tools, and even hand-operated tools such as screwdrivers and retrieving tools for picking nuts out of recesses.

2. The powered handle version can be manufactured to suit standard dimensions for the few industry-wide standards for the dimensions of attachable handles.

3. The invention provides illumination close to the working area.

4. The invention is particularly well adapted for use with perforated abrasive disks, perforated blades, and perforated backing plates and here it permits a better view of the work surface in situations where the intensity of light is low.

5. The circular-saw version of the invention is also well adapted for use in low ambient lighting, and is of assistance in directing the saw to cut along a marked line.

6. The removable handle could be used as a torch in an emergency.

7. The low-profile stick-on illuminator may have very general applications.

### VARIATIONS

1. Reasonably directed beams of light can be used in groups to provide a visible indication of perpendicularity of a power tool, such as a drill, with a flat work surface. Here, pairs of beams may be arranged so as to converge at points on each side of the drill bit and at the same distance, and the operator simply has to keep the patterns similar to each other. The two pairs may be placed at 90 degrees to each other around the chuck.

Power may be passed from the body of the electric power tool and the illuminator though contacts built into or around the position for insertion of the handle. Then, rechargeable batteries are no longer required. Or control may be imposed by the tool. However, this requires that the tool itself is modified.

Instead of a manual switch to activate illuminators, a vibration/sound sensor or a magnetic field/flux sensor or some combination may be used to determine times when the power tool is energised.

Finally, it will be appreciated that various alterations and modifications may be made to the foregoing without departing from the scope of this invention as set forth.

1. Illumination means for providing portable, locally applied illumination upon an item such as a hand-held tool, characterised in that visible light-emitting means is provided from within a housing having a low profile; the housing providing for coupling of the visible light-emitting means to a source of energy and being capable of being attached by an attachment means compatible with a variety of existing items, so that, when in place and when in use, an effective amount of light may be cast onto a work surface.

2. Illumination means as claimed in claim 1, characterised in that the attachment means comprises a layer of an adhesive material capable of holding the attachment means onto the item, and the housing for the illumination means is flexible.

3. Illumination means as claimed in claim 2, further characterised in that the light-emitting means comprises at least one filament lamp, connected to a flexible electrical conducting means; the electrical conducting means being connected to one or more sources of electric power, the at least one lamp being housed upon or within a resilient non-conducting material, so that the illumination means is capable, on installation, of conforming to a variety of shaped surfaces.

4. Illumination means as claimed in claim 3, further characterised in that the at least one filament lamp is provided with heat dissipation means comprising at least one heat conducting means laid out upon or within the housing, so that in use the heat produced by the at least one lamp is distributed about the housing.

5. Illumination means as claimed in claim 4, further characterised in that the heat dissipation means also serves as the flexible electrical conducting means and is comprised of a metal foil.

6. Illumination means as claimed in claim 2, further characterised in that the light-emitting means comprises one or more solid-state lamps and control means.

7. Illumination means as claimed in claim 1, characterised in that the illumination means is provided within a compatible, functional accessory for the power tool, so that when in place, the accessory containing the illumination means is capable of directing an effective amount of light onto the work surface as well as being capable of carrying out its usual function.

8. Illumination means as claimed in claim 7, characterised in that the accessory comprises an additional handle suitable for attachment to the hand-held tool.

9. Illumination means as claimed in claim 1, characterised in that the illumination means within the accessory is powered from a battery pack adapted to function with the accessory.

10. Illumination means for use with a hand-held tool as claimed in claim 1, characterised in that the tool is an electrically powered tool and the illumination means draws its power from the power provided to the power tool.

11. Illumination means for use with a power tool as claimed in claim 9, characterised in that the visible light is generated external to the illumination means and is carried by means of one or more light conducting pathways into the illumination means from where an effective amount of light may be cast onto a work surface.

12. Illumination means for use with a power tool as claimed in claim 11, characterised in that the illumination means is capable of producing a flashing light wherein each flash is timed so as to be substantially in phase with the presence, adjacent to the illumination means, of a perforation in the abrasive disk attached to the spindle of the angle grinder.

13. Illumination means as claimed in claim 1, characterised in that the illumination means is capable of emitting light as a series of short pulses so that the operator is provided with a view of the workplace but battery life is conserved.
